(19) United States
(12) Patent Application Publication
(10) Pub. No.: US 2025/0377908 A1
(43) Pub. Date: Dec. 11, 2025

(54) EVENT DETECTION SYSTEM AND EVENT DETECTION METHOD OF AREA

(71) Applicant: IsCoolLab Co., Ltd., Taipei City (TW)

(72) Inventor: YAN-MEI JIANG, Taipei City (TW)

(21) Appl. No.: 18/919,659

(22) Filed: Oct. 18, 2024

(30) Foreign Application Priority Data
Jun. 7, 2024 (TW) 113121135

(51) Int. Cl. G06F 9/451; G06V 20/40

(52) U.S. Cl. CPC G06F 9/451; G06V 20/44

(57) ABSTRACT

An event detection system and an event detection method of an area are provided. The area includes multiple sub-areas. Each sub-area includes an apparatus and an indication device that is disposed on one side of the apparatus and includes multiple indication signal display modules. The event detection system includes an image-capturing device that captures multiple pieces of area image information of the area and a control circuit electrically connected thereto. The control circuit analyzes the multiple pieces of the area image information for capturing an indication signal of each indication signal display module of the indication device in each sub-area, and multiple workflows are selected according to the indication signal of each indication signal display module. The control circuit executes the workflows of the apparatus in each sub-area by using one or more software operation processes, mouse operation processes, keyboard operation processes, or electronic device operation processes.

### CROSS-REFERENCE TO RELATED PATENT APPLICATION

This application claims the benefit of priority to Taiwan Patent Application No. 113121135, filed on Jun. 7, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an event detection system and an event detection method, and more particularly to an event detection system and an event detection method of an area for adjustment of corresponding workflows.

### BACKGROUND OF THE DISCLOSURE

The costs for implementing an existing event detection system and an existing event detection method of an area are high. In particular, a detection system of a production line is mostly customized according to customer requirements, especially in relation to workflow connection (e.g., robotic process automation (RPA)) of different divisions (e.g., a procurement system, a production system, and a maintenance division). Since manufacturers are dissimilar in their divisions and relevant requirements, the required costs of the detection system cannot be decreased.

### SUMMARY OF THE DISCLOSURE

In response to the above-referenced technical inadequacy, the present disclosure provides an event detection system and an event detection method of an area.

In order to solve the above-mentioned problem, one of the technical aspects adopted by the present disclosure is to provide an event detection system of an area. The area includes a plurality of sub-areas, each of the sub-areas includes an indication device and an apparatus, each of the indication devices is disposed on one side of a corresponding one of the apparatuses, and each of the indication devices includes a plurality of indication signal display modules. The event detection system includes: an image-capturing device capturing multiple pieces of area image information of the area; and a control circuit electrically connected to the image-capturing device. The control circuit analyzes the multiple pieces of the area image information of the area to capture an indication signal of each of the indication signal display modules of the indication device in each of the sub-areas, and a plurality of workflows are selected according to the indication signal of each of the indication signal display modules. The control circuit executes the workflows of the apparatus in each of the sub-areas by using at least one software operation process, at least one mouse operation process, at least one keyboard operation process, or at least one electronic device operation process.

In order to solve the above-mentioned problem, another one of the technical aspects adopted by the present disclosure is to provide an event detection method of an area, which includes: capturing multiple pieces of area image information of the area; analyzing the multiple pieces of the area image information as multiple pieces of sub-area image information; capturing an indication signal of each of a plurality of indication signal display modules in an indication device that corresponds to each of the multiple pieces of the sub-area image information; and selecting, according to the indication signal of each of the indication signal display modules in the indication device that corresponds to each of the multiple pieces of the sub-area image information, one or more workflows that correspond to the indication signal, and using at least one software operation process, at least one mouse operation process, at least one keyboard operation process, or at least one electronic device operation process to simulate operations of a user on an electronic device, so as to operate the one or more workflows that correspond to the indication signal.

Therefore, in the event detection system and the event detection method of the area as provided by the present disclosure, only one image-capturing device is needed for effectively and quickly detecting various workflows of areas that need to be detected. For the event detection system and the event detection method of the present disclosure, implementation costs can be significantly decreased. Not only can implementation be quickly achieved, but the required workflows can also be adjusted according to customer requirements.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of an event detection system of an area according to a first embodiment of the present disclosure;

FIG. 2 is another schematic diagram of the event detection system according to the first embodiment of the present disclosure;

FIG. 3 is yet another schematic diagram of the event detection system according to the first embodiment of the present disclosure;

FIG. 4 is a schematic diagram of an editing interface of the event detection system according to the first embodiment of the present disclosure; and

FIG. 5 is a flowchart of an event detection method of an area according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

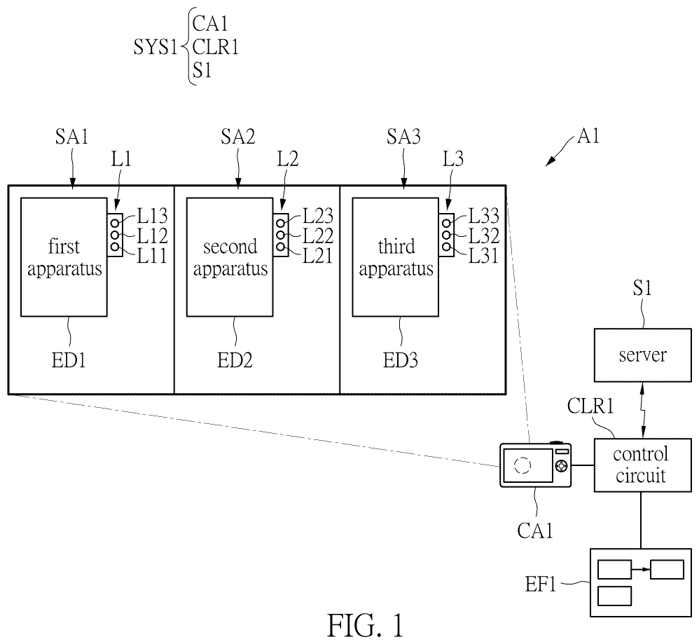

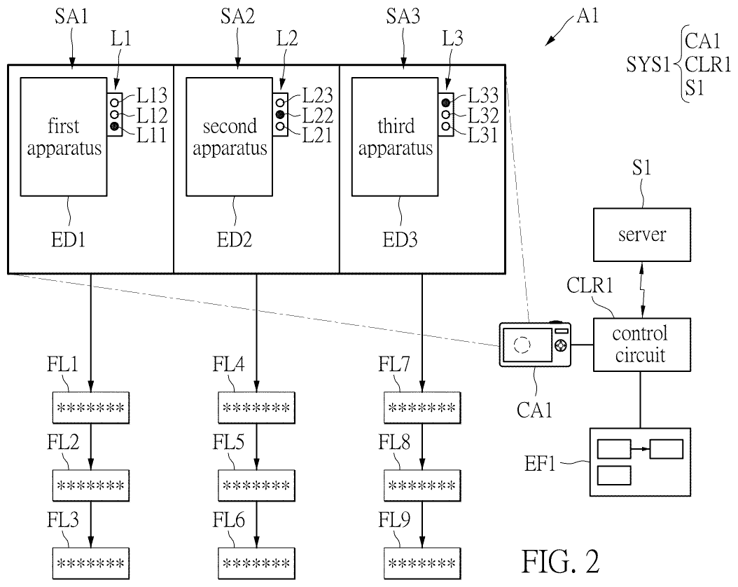

Referring to FIG. 1 and FIG. 2, FIG. 1 is a schematic diagram of an event detection system of an area according to a first embodiment of the present disclosure, and FIG. 2 is another schematic diagram of the event detection system according to the first embodiment of the present disclosure.

In the present embodiment, an event detection system SYS1 is provided. The event detection system SYS1 is applicable to an area A1. The area Al includes a plurality of sub-areas, which are a first sub-area SA1, a second sub-area SA2, and a third sub-area SA3.

Each of the sub-areas SA1 to SA3 includes an indication device (i.e., a first indication device L1, a second indication device L2, and a third indication device L3) and an apparatus (i.e., a first apparatus ED1, a second apparatus ED2, and a third apparatus ED3). Each of the indication devices L1 to L3 is disposed on one side of a corresponding one of the apparatuses ED1 to ED3. The first indication device L1 includes a first indication signal display module L11, a second indication signal display module L12, and a third indication signal display module L13. Similarly, the second indication device L2 includes a first indication signal display module L21, a second indication signal display module L22, and a third indication signal display module L23. The third indication device L3 includes a first indication signal display module L31, a second indication signal display module L32, and a third indication signal display module L33.

The event detection system SYS1 includes an image-capturing device CA1 and a control circuit CLR1. The control circuit CLR1 can include an editing interface EF1 or an application program, which is used for editing relevant workflows. In the present embodiment, multiple ones of the image-capturing device CA1 can be added in the event detection system SYS1, so as to detect apparatuses and indication devices of different areas. In the present embodiment, each of the apparatuses ED1 to ED3 can be an electronic apparatus, a mechanical apparatus, a boiler apparatus, or a pressure apparatus. However, the present disclosure is not limited thereto. In addition, the indication devices L1 to L3 are configured to provide a plurality of indication signals, and each indication signal corresponds to one of a plurality of statuses of the apparatuses ED1 to ED3. In other embodiments, the indication devices L1 to L3 do not include a plurality of display modules, and use only a dial or a numeral display. Since a plurality of situations can be represented by the dial or the numeral display, the control circuit CLR1 can also perform analysis based on directions of the dial or different numerals in the numeral display.

The image-capturing device CA1 captures multiple pieces of area image information of the area A1. The apparatuses ED1 to ED3 and the indication devices L1 to L3 are disposed in the area A1. In the present embodiment, the area image information captured by the image-capturing device CA1 needs to cover the indication devices L1 to L3. Preferably, the area image information covers all the apparatuses ED1 to ED3 and the indication devices L1 to L3.

The control circuit CLR1 is electrically connected to the image-capturing device CA1, and analyzes the multiple pieces of the area image information of the area A1, so as to capture the indication signal of each of the indication signal display modules L11 to L33 of the indication devices L1 to L3 in the sub-areas SA1 to SA3. According to the indication signal of each of the indication signal display modules L11 to L33, the control circuit CLR1 determines a plurality of workflows (a first workflow FL1 to a ninth workflow FL9) of each of the apparatuses ED1 to ED3 in a corresponding one of the sub-areas SA1 to SA3.

The event detection system SYS1 further includes a server S1. A recorded content of the workflows FL1 to FL9 of each of the apparatuses ED1 to ED3 in a corresponding one of the sub-areas SA1 to SA3 is transmitted to the server S1 by the control circuit CLR1.

The image-capturing device CA1 is a camera. Each of the indication devices L1 to L3 is a tri-color light. The indication signal display modules L11 to L33 in the indication devices L1 to L3 have different colors, which can be red, yellow, or green.

Reference is made to FIG. 2. When the control circuit CLR1 detects lighting of the indication signal display modules L11 to L33 of the apparatuses ED1 to ED3 in the sub-areas SA1 to SA3, the control circuit CLR1 provides the first workflow FL1 to the ninth workflow FL9 according to the indication signals of the indication signal display modules L11 to L33. An operation process of robotic process automation refers to connection made between the first workflow FL1 to the ninth workflow FL9 and the indication signals of the indication signal display modules L11 to L33.

In the present embodiment, the first workflow FL1 to the ninth workflow FL9 can be adjusted according to practical requirements. That is to say, the above-mentioned workflows can be customized. In an area of a first manufacturer, the first workflow FL1 to the ninth workflow FL9 can be workflows in which the server S1 is used to call maintenance personnel or record a utilization rate. In an area of a second manufacturer, the workflows FL1 to FL9 can be another set of workflows. Furthermore, when each indication signal is detected, a corresponding workflow quantity can be adjusted according to practical requirements. The workflows FL1 to FL9 of the apparatuses ED1 to ED3 provided by the control circuit CLR1 are directly related with the indication signals provided by the indication devices L1 to L3 that correspond to the apparatuses ED1 to ED3.

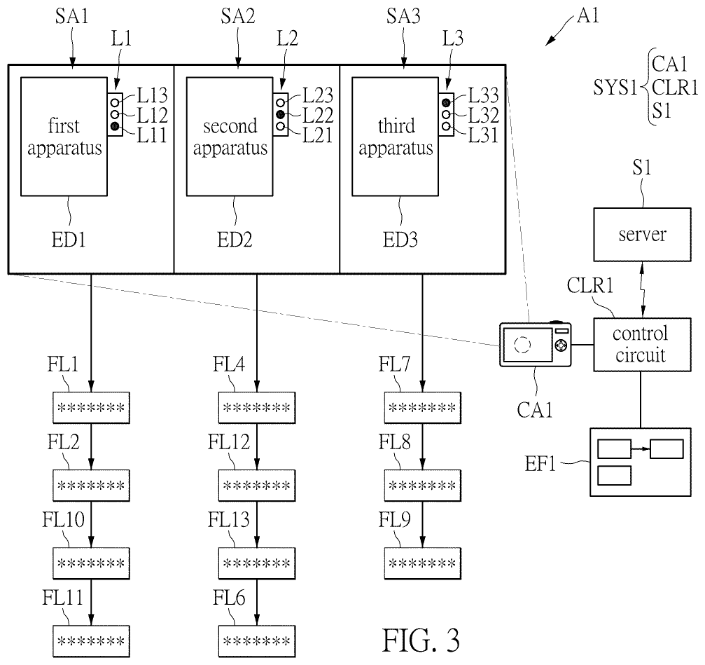

Reference is made to FIG. 3, which is yet another schematic diagram of the event detection system according to the first embodiment of the present disclosure.

According to an editing requirement signal provided by a user via the editing interface EF1, the control circuit CLR1 can adjust corresponding relationships or contents of the apparatuses ED1 to ED3, the indication devices L1 to L3, the indication signal display modules L11 to L33, and the workflows FL1 to FL9. The editing requirement signal can also be provided by a workflow editing interface (not shown in the figures) of the event detection system SYS1. Through the workflow editing interface (not shown in the figures), the user can edit relational connection of the apparatuses ED1 to ED3 in the sub-areas SA1 to SA3, relational connection between the apparatuses ED1 to ED3 and the indication devices L1 to L3, and relational connection between each of the indication signal display modules L11 to L33 of the indication devices L1 to L3 and each workflow. For example, apart from detecting the indication signals of the indication devices L1 to L3, the control circuit CLR1 can further compare operation or non-operation of the apparatuses ED1 to ED3 with the indication signals of the indication devices L1 to L3, so as to determine whether or not the apparatuses ED1 to ED3 operate abnormally or the indication devices L1 to L3 fail to accurately emit the indication signals.

Reference is made to FIG. 2 and FIG. 3. While the workflows that correspond to the first indication signal display module L11 in FIG. 2 are the first workflow FL1, the second workflow FL2, and the third workflow FL3, the workflows that correspond to the first indication signal display module L11 in FIG. 3 can be edited as the first workflow FL1, the second workflow FL2, a tenth workflow FL10, and an eleventh workflow FL11. While the workflows that correspond to the second indication signal display module L22 in FIG. 2 are the fourth workflow FL4, the fifth workflow FL5, and the sixth workflow FL6, the workflows that correspond to the second indication signal display module L22 in FIG. 3 can be edited as the fourth workflow FL4, a twelfth workflow FL12, a thirteenth workflow FL13, and the sixth workflow FL6. Furthermore, the content of each of the workflows FL1 to FL 13 can be adjusted or set according to user requirements.

The control circuit CLR1 can select the workflows FL1 to FL13 from a database (not shown in the figures). In the present embodiment, since connection relationships of the workflows FL1 to FL13 are already determined via the editing interface EF1, the control circuit CLR1 can directly execute the workflow that corresponds to each indication signal. In addition, the control circuit CLR1 executes each of the workflows FL1 to FL 13 by using at least one software operation process, at least one mouse operation process, at least one keyboard operation process, or at least one electronic device operation process. That is, each of the workflows FL1 to FL13 is executed in an electronic device (which is not shown in the figures, and can be a desktop computer in the present embodiment). This electronic device (not shown in the figures) can be connected to the image-capturing device CA1, and an image of the image-capturing device CA1 is shown on a display device (not shown in the FIGS. that is connected to the electronic device (not shown in the figures). In the present embodiment, the electronic device (not shown in the figures) can be the control circuit CLR1, or can be disposed in the control circuit CLR1. Then, each of the workflows FL1 to FL13 is executed by simulating a user operation of the electronic device (not shown in the figures). That is, the event detection system SYS1 of the present embodiment can use computer vision to simulate viewing of the image of the image-capturing device CA1 by the user. When the event detection system SYS1 views a different detection signal with use of the computer vision, the event detection system SYS1 executes a corresponding one of the workflows of the electronic device (not shown in the figures) via the control circuit CLR1. Each of the workflows FL1 to FL13 is formed by one or more operation processes of the at least ones software operation process, the at least one mouse operation process, the at least one keyboard operation process, or the at least one electronic device operation process.

In the present embodiment, the control circuit CLR1 can be implemented by using hardware. In other embodiments, the control circuit CLR1 can be implemented by cooperation of hardware (e.g., a programmable chip or a central processing unit (CPU)) and software. However, the present disclosure is not limited thereto.

Furthermore, the editing interface EF1 can be displayed on a display device, a desktop computer, a smartphone, or a tablet computer, such that the user is allowed to perform editing.

In other embodiments, other than being the tri-color light, each of the indication devices L1 to L3 can also be a dial indicator, a dial manometer, or a numeral display indicator. That is, the control circuit CLR1 can not only detect the color, but can also detect dial change, numeral change, or motion change. As such, the indication devices L1 to L3 can provide a light indication signal, a dial indication signal, a numeral indication signal, or a motion-content indication signal.

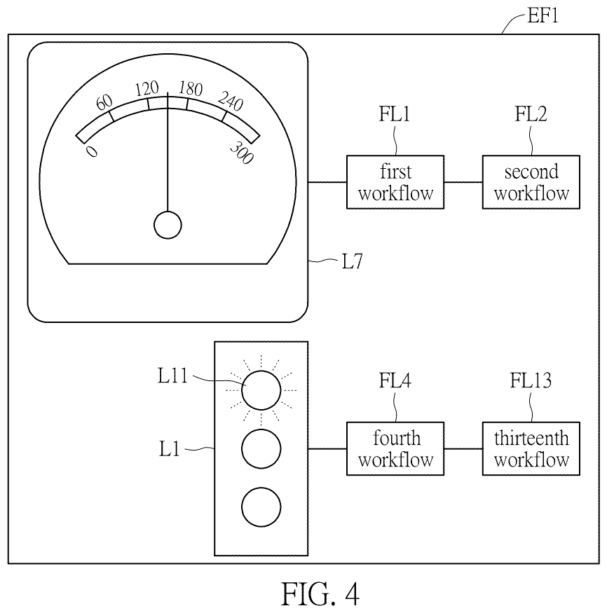

Reference is made to FIG. 4, which is a schematic diagram of an editing interface of the event detection system according to the first embodiment of the present disclosure.

When editing is performed on the editing interface EF1, the editing interface EF1 is correspondingly linked to the workflows FL1 to FL13 according to indication image information, a color, or a shape of the indication signal.

In FIG. 4, an indication device L7 (which is a dial indication device) is linked to the first workflow FL1 and the second workflow FL2. When lighting up, the first indication signal display module L11 of the first indication device L1 is linked to the fourth workflow FL4 and the thirteenth workflow FL13.

### Second Embodiment

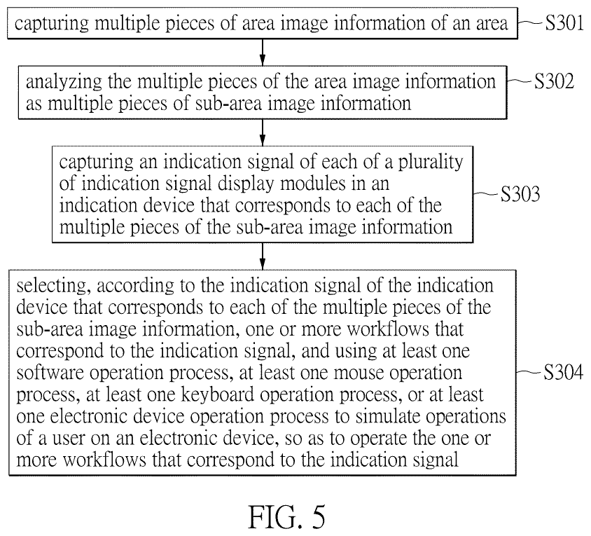

Reference is made to FIG. 5, which is a flowchart of an event detection method of an area according to a second embodiment of the present disclosure.

The present embodiment provides an event detection method of an area that is applicable to the event detection system SYS1 of the first embodiment, and the structure and the function of the event detection system SYS1 will not be reiterated herein.

The event detection method includes the following steps.

Step S301: capturing multiple pieces of area image information of the area.

Step S302: analyzing the multiple pieces of the area image information as multiple pieces of sub-area image information.

Step S303: capturing an indication signal of each of a plurality of indication signal display modules in an indication device that corresponds to each of the multiple pieces of the sub-area image information.

Step S304: selecting, according to the indication signal of the indication device that corresponds to each of the multiple pieces of the sub-area image information, one or more workflows that correspond to the indication signal, and using at least one software operation process, at least one mouse operation process, at least one keyboard operation process, or at least one electronic device operation process to simulate operations of a user on an electronic device, so as to operate the one or more workflows that correspond to the indication signal.

In step S301 and step S302, the area image information captured by the image-capturing device CA1 is divided according to the quantity of the apparatuses ED1 to ED3, and relational connection is established based on commands from the indication devices L1 to L3 that are respectively disposed on the apparatuses ED1 to ED3 in the sub-areas SA1 to SA3. That is, apart from detecting the indication signals of the indication devices L1 to L3, the control circuit CLR1 can further compare operation or non-operation of the apparatuses ED1 to ED3 with the indication signals of the indication devices L1 to L3, so as to determine whether or not the apparatuses ED1 to ED3 operate abnormally or the indication devices L1 to L3 fail to accurately emit the indication signals.

In the present embodiment, the sub-areas SA1 to SA3, the apparatuses ED1 to ED3, and the indication devices L1 to L3 are correspondingly linked.

According to lighting of the indication signal of each of the indication devices L1 to L3, the control circuit CLR1 records and compares corresponding ones of the workflows.

For example, when the control circuit CLR1 detects lighting of the first indication signal display module L11 of the first apparatus ED1 in the first sub-area SA1, the control circuit CLR1 provides the first workflow FL1, the second workflow FL2, and the third workflow FL3 according to the indication signal of the first indication signal display module L11. The first workflow FL1 is to perform a shut-down within a specific time interval. The second workflow FL2 is to call the maintenance personnel. The third workflow FL3 is to determine whether or not operation of the first apparatus ED1 is resumed within a predetermined time interval (e.g., one hour). According to the area image information captured by the image-capturing device CA1, the control circuit CLR1 determines whether or not the first workflow FL1, the second workflow FL2, and the third workflow FL3 mentioned above are completed within a predetermined time. The control circuit CLR1 also records a completion time of each workflow, and transmits the same to the server S1. The operation process of the robotic process automation refers to connection made between each workflow and the indication signal of the indication signal display module.

In step S303, the control circuit CLR1 will detect the indication signals of the indication devices L1 to L3 that correspond to the apparatuses ED1 to ED3 in the sub-areas SA1 to SA3.

In step S304, a recorded content of the workflows of an apparatus in each of the sub-areas SA1 to SA3 that corresponds to one piece of the sub-area image information is transmitted to the server S1.

### Beneficial Effects of the Embodiments

In conclusion, in the event detection system and the event detection method of the area as provided by the present disclosure, only one image-capturing device is needed for effectively and quickly detecting various workflows of areas that need to be detected. For the event detection system and the event detection method of the present disclosure, implementation costs can be significantly decreased. Not only can implementation be quickly achieved, but the required workflows can also be adjusted according to customer requirements.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An event detection system of an area, the area including a plurality of sub-areas, each of the sub-areas including an indication device and an apparatus, each of the indication devices being disposed on one side of a corresponding one of the apparatuses or on the corresponding one of the apparatuses, each of the indication devices being configured to provide a plurality of indication signals, and the event detection system comprising:
an image-capturing device capturing multiple pieces of area image information of the area; and
a control circuit electrically connected to the image-capturing device, wherein the control circuit analyzes the multiple pieces of the area image information of the area to capture the indication signal provided by the indication device in each of the sub-areas, and a plurality of workflows are selected according to the indication signal provided by each of the indication devices; wherein the control circuit executes the workflows of the apparatus in each of the sub-areas by using at least one software operation process, at least one mouse operation process, at least one keyboard operation process, or at least one electronic device operation process;
wherein the workflows of each of the apparatuses provided by the control circuit are directly related with the indication signal captured by image-capturing device and provided by the indication device that corresponds to the apparatus.

2. The event detection system according to claim 1, further comprising: a server, wherein a recorded content of the workflows of the apparatus in each of the sub-areas is transmitted to the server by the control circuit, and the indication device provides a light indication signal, a dial indication signal, a numeral indication signal, or a motion-content indication signal;
wherein the at least one software operation process, the at least one mouse operation process, the at least one keyboard operation process, and the at least one electronic device operation process of the control circuit are simulations of a plurality of operation processes performed by a user on an electronic device.

3. The event detection system according to claim 2, wherein a workflow quantity of the workflows related with each of the indication signals is adjustable, a workflow content of each of the workflows related with each of the indication signals is adjustable, a sequence of the workflows that correspond to the indication signal of each of a plurality of indication signal display modules in the indication device is adjustable, and a determination standard of the indication device is adjustable; wherein the image-capturing device is a camera.

4. The event detection system according to claim 3, wherein the control circuit is connected to an editing interface, and the workflow quantity of the workflows, the workflow content of each of the workflows, and the sequence of the workflows of each of the indication signals are edited and adjusted via the editing interface; wherein, when editing is performed on the editing interface, the editing interface is correspondingly linked to the workflows according to indication image information, a color, or a shape of the indication signal.

5. The event detection system according to claim 4, wherein each of the indication devices is a tri-color light, a dial indicator, a dial manometer, or a numeral display indicator; wherein, when the indication device is the tri-color light, each of the indication signal display modules in the indication device has a different color.

6. The event detection system according to claim 5, wherein the workflows are determined by recording and simulating the operation processes performed by the user on the electronic device.

7. An event detection method of an area, comprising:
capturing multiple pieces of area image information of the area;
analyzing the multiple pieces of the area image information as multiple pieces of sub-area image information;
capturing one or more indication signals provided by an indication device that corresponds to each of the multiple pieces of the sub-area image information; and
selecting, according to the indication signal of the indication device that corresponds to each of the multiple pieces of the sub-area image information, one or more workflows that correspond to the indication signal, and using at least one software operation process, at least one mouse operation process, at least one keyboard operation process, or at least one electronic device operation process to simulate operations of a user on an electronic device, so as to operate the one or more workflows that correspond to the indication signal.

8. The event detection method according to claim 7, wherein a recorded content of the workflows of an apparatus in a sub-area that corresponds to each of the multiple pieces of the sub-area image information is transmitted to a server; wherein the indication device provides a light indication signal, a dial indication signal, a numeral indication signal, or a motion-content indication signal.

9. The event detection method according to claim 8, wherein the event detection method is applicable to an event detection system, the event detection system includes an image-capturing device and a control circuit, and the control circuit is electrically connected to the image-capturing device; wherein the image-capturing device is a camera, and is disposed on one side of the apparatus; wherein the control circuit is connected to an editing interface, a sequence of the workflows and a workflow content of each of the workflows are edited and adjusted via the editing interface, and a workflow quantity of the workflows is edited and adjusted via the editing interface; wherein, when editing is performed on the editing interface, the editing interface is correspondingly linked to the workflows according to indication image information, a color, or a shape of the indication signal; wherein the at least one software operation process, the at least one mouse operation process, the at least one keyboard operation process, and the at least one electronic device operation process of the control circuit are simulations of a plurality of operation processes performed by the user on the electronic device.

10. The event detection method according to claim 9, wherein each of the indication devices is a tri-color light, a dial indicator, a dial manometer, or a numeral display indicator; wherein, when each of the indication devices is the tri-color light, the indication device includes a plurality of indication signal display modules, and each of the indication signal display modules in the indication device has a different color; wherein the workflow quantity of the workflows related with each of the indication signals is adjustable, the workflow content of each of the workflows related with each of the indication signals is adjustable, the sequence of the workflows that correspond to the indication signal of each of the indication signal display modules in the indication device is adjustable, and a determination standard of the indication device is adjustable; wherein the workflows are determined by recording and simulating the operation processes performed by the user on the electronic device.
